(19) United States
(12) Patent Application Publication
(10) Pub. No.: US 2017/0364816 A1
(43) Pub. Date: Dec. 21, 2017

(54) Prediction of Discernible Fungus Establishment on a Crop

(71) Applicant: aWhere, Inc., Broomfield, CO (US)

(72) Inventors: Drew Chandler William Marticorena, Durham, NC (US); John Dorschel Corbett, Denver, CO (US); Daniel Joel Allen, Greensboro, NC (US); Stewart Neville Collis, Carrboro, NC (US); Kristopher Thomas Michael Landon, Wake Forest, NC (US)

(21) Appl. No.: 15/689,744

(22) Filed: Aug. 29, 2017

(51) Int. Cl. G06N 5/04; G06Q 50/02; G06Q 10/06

(52) U.S. Cl. CPC G06N 5/048; G06Q 10/0631; G06Q 50/02

(57) ABSTRACT

A method to predict whether a particular fungus will be observed by a scout checking on a particular crop at a particular location on a particular date. The method using a set of previous scouting reports and weather information for the particular location, including weather information for a period of time before the particular date.

### BACKGROUND

### Field of the Disclosure

This disclosure relates generally to predictions of establishment of fungus in an agricultural crop based at least in part of the use of a model predicting leaf wetness.

Fungus Cycle.

Fungi propagate by releasing spores. These spores may travel with the wind and land on a wet leaf of a plant that may serve as a host. When a spore has landed, under proper conditions including leaf wetness and temperature, the spore will put forth root-like threads called hyphae (singular is hypha). This change from a spore to an active fungus is called germination. After germination, a fungus may be called a mycelium.

During periods that support the growth of the hyphae, the hyphae will penetrate the outer surface of the host plant (both leaves and stem) and attempt to become established. The movement of the hyphae into the plant may be called burrowing. The plant will attempt to ward off being penetrated by the hyphae. If there is a prolonged dry period without favorable conditions to support the continued growth of the hyphae, then the effort by the hyphae to become established fails and the fungus will need to start the process of burrowing into the plant anew.

If the hyphae are successful in establishing the fungus spore on the plant, the hyphae extract nutrients from the plant to promote growth of the fungus and the eventual release of spores to repeat the process. Once the fungus is established, it is no longer practical in an agricultural field to rid infected plants of the fungus. Anti-fungal agents are most effective at stopping the burrowing efforts of the hyphae before the fungus is sufficiently established. Once the fungus is established, it is very difficult for anti-fungal agents to rid the plant of the established fungus although the treatment may stop the establishment of additional amounts of fungus in that field.

Note that there are three levels of fungus presence. These levels are like the onset of dawn in that it is somewhat subjective where you draw the line, but yet we all understand that dawn, midday, and dusk are different states.

Established.

The first state is that fungus has become established. Thus the fungus spores have had hyphae effectively tap into the plant so that the fungus is now established and won't be set back by an extended period of dry weather as the fungus has tapped the plant. Once the fungus is established on the crop, the fungus will release additional spores which will work to become established. Additionally, spores that were carried in by the wind to the crop after the earliest spores that became established may soon become established as the weather conducive to establishing the first spores may be part of a sequence to establish later arriving spores.

Discernible

It is the discernment of established fungus by scouts that is used to tune the model. As described below, scouts make physical visits to fields to look for various things including a discernible level of fungus. This may require some additional fungus presence beyond the initial establishment as a scout making a visit with limited time is not able to check the entire surface area of the field section being sampled. Thus there may be some gap between theoretical establishment that may be detectable under intense scrutiny in a laboratory and a discernible establishment under field conditions by a scout.

Agronomically Significant Damage—

Some minor establishment, even if discernible by the scouts is tolerable and not agronomically significant. The crop is still valuable and timely intervention to apply fungicides and provide other treatment (such as adding nutrients to help the plants fight the fungus) may preserve the economic value of the crop. This is why farmers employ scouts to look for the onset of fungal damage in time to take corrective action.

Laboratory Studies.

The ambient humidity and temperatures necessary for fungus to be established under laboratory controlled greenhouses has been studied. It would be useful to various players in the agricultural ecosystem to understand which fields growing particular crops are apt to be at risk of having a particular fungus become established. This can lead to actions to attempt to fight off the fungus.

The prediction of the establishment of a particular type of fungus on a particular crop in a particular field would be based on the weather experienced at that particular field. Thus, there is a combination of predicted weather conditions and biological phenomenon in order to provide actionable predictions of which specific fields will be likely to have the establishment of a specific fungus if no action is taken.

Simulated Annealing.

The teachings of the present disclosure include use of a parameter optimization technique in order to tune a model to perform with high predictive accuracy across the agricultural landscape. One parameter optimization technique that has been used successfully with the teachings of the present disclosure is simulated annealing. As this disclosure does not purport to have invented simulated annealing, it is appropriate to introduce simulated annealing here in the background section. A complete discussion of this technique is beyond the scope of the present disclosure. A more detailed summary is provided at https://en.wikipedia.org/wiki/Simulated_annealing and there are many articles that address the nuances of this technique.

Annealing, in metallurgy and materials science, is a heat treatment that alters the physical and sometimes chemical properties of a material to increase its ductility and reduce its hardness, making it more workable. It involves heating a material to above its recrystallization temperature, maintaining a suitable temperature for a period of time, and then cooling the material under controlled conditions.

Simulated annealing mimics the physical annealing process to solve an optimization problem. It uses a temperature parameter that controls the inherent variability of the parameter search. The simulated annealing temperature parameter starts off high and is slowly “cooled” or lowered in every iteration. At each iteration, a new point in the parameter space being searched is generated with its potential distance from the current point being a function of the simulated annealing temperature.

The simplest type of parameter optimization algorithm is a “greedy search”: in such an algorithm the intuitive approach is taken to vary the inputs in some manner and always take the best result found to date as the basis for choosing the next set of parameters. Unfortunately, this simplistic optimization approach can lead to quickly converging on a local maximum and reducing the likelihood of finding the global maximum. This can be envisioned as having a rule that you will only walk uphill with the hope of getting to the tallest mountain peak. This simple strategy will not necessarily lead you to the tallest mountain peak as it may be beyond several valleys separating your current location from the tallest mountain peak.

Simulated annealing has a non-intuitive property making it possible for the algorithm to accept and use as the basis for choosing the next set of chosen parameters a result worse than the best found to date. Rather than always choosing a new parameter combination when that combination has a better output than the old baseline, it is possible to move from a good result to a less good result. The probability of doing so is inversely dependent on the “temperature”. This non-intuitive step sometime helps identify a new search region in hope of finding a better solution than would come from a local optimum. Using the previous analogy, this is akin to being willing to walk downhill to ultimately reach the peak of the highest mountain.

An annealing schedule is selected to systematically decrease the temperature as the algorithm proceeds. As the temperature decreases, the algorithm reduces the variability of its search and its willingness to accept worse solutions as it converges to an approximately optimal solution. The rate of temperature decrease is calibrated so that algorithm has time early on to explore the overall parameter space coarsely and then to ultimately explore the most promising region of parameter space in high detail to find an approximate of the global maximum.

In the present work, one can use what is known as area under the curve (AUC) methodologies for assessing whether optimal parameters have been found using the algorithm.

### Related Art

U.S. Pat. No. 9,076,118 was issued Jul. 7, 2015 to Iteris, Inc. for a patent with the lengthy title of: Harvest Advisory Modeling Using Field-Level Analysis Of Weather Conditions, Observations And User Input Of Harvest Condition States, Wherein A Predicted Harvest Condition Includes An Estimation Of Standing Crop Dry-Down Rates, And An Estimation Of Fuel Costs.

The '118 patent provides a current example of patentable subject matter under 35 USC §101 as understood after the Supreme Court cases in Alice Corporation Pty. Ltd. v. CLS Bank International, et al. and Bilski v. Kappos. The '118 patent taught processing weather information and crop-specific information for an agricultural commodity to be harvested and providing useful outputs to farmers including advisories of predicted harvest conditions, predicted temporal harvest windows, assessments of indicators of plant suitability for harvest, estimation of fuel costs for post-harvest drying, and an estimation of loss of field workability due to frost formation in soil prior to post-harvest tillage.

U.S. Pat. No. 9,563,852 was issued on Feb. 7, 2017 to Iteris, Inc. for a patent with the title: Pest Occurrence Risk Assessment and Prediction in Neighboring Fields, Crops And Soils Using Crowd-Sourced Occurrence Data. The '852 patent teaches accepting a wide range of input data including the presence or absence of a pests in particular fields. The process is fairly non-specific pattern matching as described by this excerpt from the Brief Summary of the Invention of the '852 patent.

The present invention develops an infestation suitability model that is initiated by selecting, from all available crop management and weather data about infested fields, that data which is estimated to provide appropriate correlations with pest presence. This may be thought of as an a priori selection of potential descriptors, based on knowledge of the population and spatial dynamics of the pests. The present invention then puts the selected descriptors in an unsupervised learning method engine (or, an ensemble of such methods) to look for patterns in the selected data and the relation to characteristics of targeted fields to develop one or more environmental and crop management predictors based on a multivariate similarity of variable values among the selected set of descriptors. This narrows the set of descriptors and determines their relative importance, and in some cases, the form of the relationship between the environmental variable and the likelihood of a pest problem. This resulting infestation suitability model is used to develop a risk assessment profile, which is applied to perform a calculation of the risk. The risk assessment profile may also be applied to generate a ranking of risk of targeted fields. Every time additional observations of pest presence are received, the present invention enhances its predictive capabilities by modifying the pest-environmental relationship described by the infestation suitability model, so that the model is both adaptive and dynamic.

Vocabulary.

Or.

Unless explicit to the contrary, the word “or” should be interpreted as an inclusive or rather than an exclusive or. Thus, the default meaning of or should be the same as the more awkward and/or.

### SUMMARY OF THE DISCLOSURE

Aspects of the teachings contained within this disclosure are addressed in the claims submitted with this application upon filing. Rather than adding redundant restatements of the contents of the claims, these claims should be considered incorporated by reference into this summary.

This summary is meant to provide an introduction to the concepts that are disclosed within the specification without being an exhaustive list of the many teachings and variations upon those teachings that are provided in the extended discussion within this disclosure. Thus, the contents of this summary should not be used to limit the scope of the claims that follow.

Inventive concepts are illustrated in a series of examples, some examples showing more than one inventive concept. Individual inventive concepts can be implemented without implementing all details provided in a particular example. It is not necessary to provide examples of every possible combination of the inventive concepts provide below as one of skill in the art will recognize that inventive concepts illustrated in various examples can be combined together in order to address a specific application.

Other systems, methods, features and advantages of the disclosed teachings will be immediately apparent or will become apparent to one with skill in the art upon examination of the following figures and detailed description. It is intended that all such additional systems, methods, features and advantages be included within the scope of and be protected by the accompanying claims.

Aspects of the present disclosure may be summarized as an alternative to finding the parametric impact of any one variable as is traditionally done in regression. Instead of using statistical techniques to estimate the unique impacts of individual variables, the methodologies set forth in this disclosure is somewhat akin to the process of pattern recognition. Essentially the statistical question to be addressed is how to detect specific patterns in the weather that predict that a certain fungus has been able to grow in a specific field growing a specific crop.

In some instances to achieve robust accuracy, the model needs to consider the weather over a sixty day period. Instead of looking at each variable individually, optimization algorithms were used to determine what suite of models and associated parameter values allows a binary classification task (fungus/no fungus) with the maximum accuracy. The model efforts found that it is not effective to consider any one weather variable in isolation but is effective to consider a suite of weather variables at one time because it is the complex interaction of environmental conditions that influence the growth rate of fungus, not just temperature, relative humidity, or any other single weather attribute.

### BRIEF DESCRIPTION OF THE FIGURES

The disclosure can be better understood with reference to the following figures. The components in the figures are not necessarily to scale, emphasis instead being placed upon illustrating the principles of the disclosure. Moreover, in the figures, like reference numerals designate corresponding parts throughout the different views.

FIG. 1 is a high-level representation of a process for forecasting conditions conducive to establishment of a particular type of fungus on a particular crop

### DETAILED DESCRIPTION

Grid Box Location.

The teachings of the present disclosure make use of weather data and weather predictions that are used as inputs to fitted leaf wetness models in order to ultimately predict the growth rates of a type of fungus on a specific species of crop.

It is known in the art to model weather for a series of grids boxes. The grid boxes are typically defined by a range of longitude and a range of latitude. Each grid box may be identified by a particular longitude and latitude value for a centroid of the grid. Other conventions are possible such as identifying the grid box by the longitude and latitude of the Northwest corner.

Thus a model is not run to predict what will happen specifically to Farmer Brown's field as Farmer Brown's property may straddle two or more grids and may have several crops planted on the property. Likewise the scouting reports (discussed below) indicate the presences or absence of a discernible amount of specific fungus on a specific crop in a small sample space with associated with a specific longitude and latitude. That longitude and latitude will be part of one particular grid box while not necessarily corresponding to a centroid of a previously defined grid pattern.

An example of the level of granularity that can be useful is 5 arc minutes of longitude and 5 arc minutes of latitude. This sizing would produce at the equator a grid box of 9 kilometers by 9 kilometers. While one may prefer a grid matrix with smaller granularity, a useful model would require weather data inputs proportional to the granularity of the grid boxes. The altitude of the grid box could be the altitude of the centroid for that grid box, or the average altitude of the grid box. For many of the crops of interest, the crops are grown on large relatively flat fields so changes in altitude within a grid box are not severe. Those of skill in the art will recognize that more precise altitude information may be of use for a crop such as wine grapes that is grown on a series of steep hills as the rapid change in elevation may be relevant.

aWhere Inc. of Broomfield Colorado (www.awhere.com) is a provider of weather information for the agriculture industry. The weather information is based on a combination of a large set of ground stations that collect information such as temperature and precipitation. This may be combined with satellite and radar information. Naturally, a ground station is not present at every possible location so the actual measurements at a finite number of ground stations is used to estimate the weather at positions between the measured points so that a weather prediction is made for the centroid of each of the grid boxes. The weather prediction at a given grid box for the relevant past and the future period of interest is an input to the system described within this disclosure and not the focus of the disclosure.

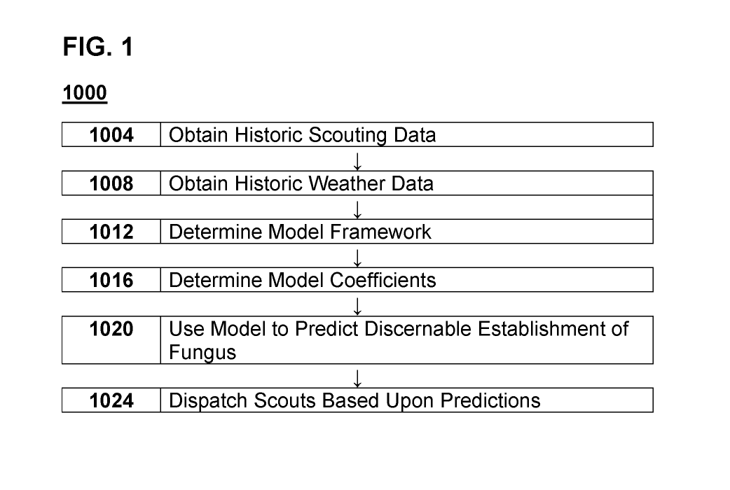

FIG. 1 shows a high-level representation of a process 1000 for forecasting conditions conducive to establishment of a particular type of fungus on a particular crop to a level that would be discernible to a scout. Non-limiting examples of the fungi of interest include: Common Corn Rust, Soybean Rust, Northern Corn Blight, and Gray Leaf Spot.

STEP 1004—Obtain historic scouting data for a particular crop/fungus pair at various latitude/longitude locations on specific dates over a time range. Data must include both positive and negative observations. In other words, the data must include instances where the fungus is discernible and instances where the fungus is not discernible and possibly not even present. A scouting trip is an actual visit of a person to a field to assess the field for the presence of a particular fungus. The data for a scouting trip visit to a particular location on a particular date may include:

Date and time;

Longitude/Latitude and possibly elevation;

Type of Crop; (Note the type of crop may not get down into the specific cultivar or variety but just be the more generic category of the type of crop. One of skill in the art will appreciate that the teachings of the present disclosure may be extended to more particularized scouting reports that include the specific cultivar, variety, or seed source, especially when certain sub-groups of a crop are thought to have a different level of susceptibility to a particular fungus than other sub-groups of that same crop). The scouting report would be mapped to the grid box pattern so that the scouting report values would be associated with a particular grid box containing the scouted field.

Discernible presence of established fungus; (typical scouting reports provide a yes/no for presence rather than any sort of gradation. One of skill in the art will recognize that the ability of a scout making one of a number of visits to different fields on a given day may not discern minute quantities of established fungus as the scout is not going to check the entirety of the surface area of the crop. The process of examining crops by scouts has a long history and is understood to detect the onset of fungus while there is ample time to treat the crop and preserve economic value of the crop.

One of skill in the art will be able to use a set of scouting reports from a series of years and then check to see whether there is any reason that the more recent past year's data should be weighted more heavily than earlier year's data. This is known as checking whether the data is stationary. One technique is to check the results by using out of sample validation across years.

Note as most of the scouting reports will indicate that the fungus is not discerned, it may be helpful to the model process to take a first subset of scouting reports that all show the discernible presence of fungus and then obtain a random sample of other scouting reports (where the fungus is not discerned) so that the combination of the two sets is a subset of the overall set of scouting reports with approximately 50% concentration of fungus-discerned reports.

Step 1008—Obtain historic weather information records sufficient to deduce what pattern of relevant weather attributes is predictive of the presence of a crop/fungus pair over the x/y locations considered over the full time range corresponding to the scouting data set used for model training. The modelling process may initially start with an extended weather sample before the date of each scouting report (maybe 120 days). The model may find that weather data is only relevant for the period of 60 days before the date of the scouting report. The historic weather information may include:
Temperature;
Humidity;
Wind speed;
Solar radiation; and
Other weather attributes as relevant to a particular model.

Those of skill in the art will recognize that given several measured parameters that intermediate parameters such as dew point can be calculated and used within the model.

The weather model may take into account topography as differences in elevation can impact local weather conditions.

Frequently, the weather data will be used to predict leaf wetness. Leaf wetness duration is a driving variable in many epidemiological models for simulating risk of yield losses due to fungus growth on plants.

Leaf wetness is related to the epidemiology of many important crops, because leaf wetness influences:
1) the germination of fungal spores;
2) the penetration of the fungal hyphae through the leaves; and
3) the occurrence of primary and secondary infections during the same season.

For these reasons, leaf wetness is often modeled and is often essential for the forecasting of the development rates of fungus hyphae to establishment of the fungus on the plant and, consequently, for crop protection. The process to pick a suitable model for a particular fungus/crop combination may include selection from a set of different leaf wetness models to find the model or models that are most useful to predict the presence of fungus. Thus, the simulated annealing or other parameter optimization technique may evaluate different models that have different choices of leaf wetness models.

A high level description of how predictions are made for when the leaves are wet is as follows. Fungus growth can only occur during periods of time where the leaves of the infected plant are wet (i.e. wet hours). In the fungus model, each type of fungus has a temperature range in which the hyphae can grow while the leaves have the required wetness, and a maximum duration of “dry” hours that can occur between “wet” hours before the hyphae dies off (As discussed below, the Magarey 2005 paper had a focus on the number of dry hours to effect a 50% die off and the model as implemented by the present disclosure used dry hours to kill off essentially all the hyphae.) In the event that the fungus hyphae die off before becoming established, the growth level for the fungus is reset to zero. See A Simple Generic Infection Model for Foliar Fungal Plant Pathogens, R. D. Magarey, T. B. Sutton, and C. L. Thayer, Phytopathology 2005 95:1, 92-100 (“Magarey 2005”).

Step 1012—Determine Model Framework. Review the literature and find suggested parameters and a model that would be useful for a model for this particular fungus/crop pair. Thus, beyond knowing that parameters X, Y, and Z are deemed relevant parameters, it is useful at this stage to be able to know that the model uses these parameters as B1*X+B2Y, +B3Z versus B1X*B2Y*B3Z raised to the B4 power. So it is not just the list of parameters, but an expected framework for the model structure. This framework will often have a relationship to the current understanding of the biology. As noted above, this will frequently include the parameters needed to predict leaf wetness and temperature values ranges where hyphae can grow while the leaves have the required wetness.

Step 1016—Use a parameter optimization technique (such as simulated annealing) to determine the optimal set of model coefficients (the Bs from above) that work with the set of parameters within a framework to provide a high predictive accuracy on the binary discrimination task of whether on a specific date at a specific latitude/longitude, a certain crop/fungus combination will be present. The efforts to find an optimal set of model coefficients can be assisted by using appropriate starting values for the simulated annealing algorithm. The appropriate starting values may come from earlier controlled laboratory studies that parametrically to determine its unique impact. Alternatively and only if available, the set of fitted coefficients from a previously created growth prediction model for a fungus that is similar biologically to the fungus being studied is an excellent starting point. A model for the same fungus on a different crop would likely be a better starting point than a model for a different fungus on the same crop.

One of the variables that may be solved for in the parameter optimization effort may be the choice from set of at least two leaf wetness models. As noted below, the choice of leaf wetness model may be made by setting the leaf wetness model as fixed in a particular parameter optimization effort and then using a different leaf wetness model in subsequent parameter optimization efforts. Eventually one model using one leaf wetness model within it may be found superior to other models that used different lead wetness models.

Different leaf wetness models may do a better job of predicting leaf wetness for a particular crop or in a particular part of the country. Warm dry winds may be very important in one model; sunlight may be a dominant factor in another model. By testing different leaf wetness model assumptions in parallel parameter optimization efforts, one does not have to overthink which leaf wetness model would be the best in a given situation.

While having a laboratory study or prior fitted model to provide a starting point for the model is not strictly required, but as a practical matter, it is highly desirable. A recognized problem with using these algorithms with large models (large in terms of the number of parameter that theoretically could all change simultaneously) is the size of the parameter space that must be searched. For example, imagine a model that has only five varying parameters each of which can have only 1 of 10 values. That equates to 100,000 combinations. Assuming that each iteration takes about five minutes to run—that would be runtime of almost 347 days. This fact highlights the need to ensure that the algorithm starts in a sensible location instead of spending a lot of time exploring what is essentially a useless part of the overall parameter space.

A typical practice to ensure that you have found the “best” solution to your model is that you perturb the starting values of the parameter optimization algorithm by some amount and then rerun the model fitting process multiple times to see if you get essentially the same results on each run. The value of using sensible starting values to reduce the time to get suitable results is well accepted.

For a model with a 60 day window, on day50 you could just insert the 10 day historic pattern for what the average weather characteristics are for that period of the year in those fields from accumulated historic data.

This model therefor can be used to determine future presence of a scout discernible level of a crop/fungus combination at specific fields given both the observed weather and forecasted future weather. This is done by using the model with the set of coefficients for the model determined as set forth above.

Step 1020—After a model has been fit to historic data, the model can be used against the weather (measured or estimated) for a given grid box over a period of days and predict whether the observed sequence of weather is going to produce conditions for a particular fungus to become scout discernably established on a particular crop in a particular grid box. Predicted weather may be done with a weather model or may be done by looking at the historic weather data.

Thus if the model is being run at the end of April, one could simply input the average weather parameters for different hours of the day for the first several weeks in May and June to assess risk of the fungus becoming established. This approach would be consistent with making a prediction of whether the fungus would take hold on the crop if the typical weather conditions were to take place going forward. Those of skill in the art will recognize that once a viable model is created for the discernible establishment of a particular fungus on a particular crop based upon the sequence of weather conditions experienced by that location, that the model can be used with a mix of measured/interpolated weather and predicted weather. The predicted weather may come from historical averages or it may come from long term weather forecasts.

Note that the number of days of weather to be used in the model may be X days for a first model for a first fungus/crop combination and Y days (where Y does not equal X) for second model for the first fungus/crop combination and Z days for a third model for a second crop/fungus combination.

The output of the model may be continuous but can be converted to a binary prediction (has scout discernible levels of fungus or does not have scout discernible levels of fungus) based upon the historical record. Depending on the consumers of the data, it may be sufficient to predict the that weather projections for a particular location coupled with recent weather suggest that X days out that this is likely to be a scout discernible presence of fungus so that an aggressive fungus management plan can be implemented before scout confirmation.

A data consumer that does not have the ability to treat fields (such as an economist seeking to predict regional yields for a crop, may benefit from predictions of scout discernible fungus levels as a year with higher incidence rates of scout discernible fungus levels may be year with greater damage/loss to crops as not all crops will obtain adequate treatment to ward off agronomically significant fungus levels). Alternatively, the model can provide likelihood rather than a yes/no that the fungus will be present at a level to be scout discernible.

Those of skill in the art understand that a model may be judged on both the ability to accurately predict a scout discernible level of fungus when fungus is indeed present at a level to be scout discernible (true positive rate) and the ability to minimize the prediction of fungus at a scout discernible level of fungus when fungus is not present at a scout discernible level (false positive rate). Depending on the nature of the fungus and the economics of a false positive (resources expended to check or treat a field that does not have the fungus) the conversion from a continuous prediction output to a binary measure may be biased to err on the side of false positive or to err on the side of false negatives.

For every grid box, the model outputs a single number with a range between 0 and positive infinity that indicates a likelihood that a field within a particular gird box growing a particular crop will have a particular fungus. (One of skill in the art will appreciate that the numbers could be scaled to some other numeric range.)

Part of the process is to set a threshold (TDV as discussed below) for the single number that is the cutoff between likely to have fungus established sufficiently to be readily discerned by a scout and unlikely to have fungus established to the state of being scout discernible. Thus, the threshold may be set initially for a new growing season based on a threshold that worked well across a number of grid boxes for that crop/fungus pair in the prior year or years. The model may have discerned that data from more recent years are to be given greater weight than data from earlier years but often the data from all years will be given equal weight. Fields in grid boxes with numbers above a particular historic threshold may have a scout dispatched to check for the discernible presence of established fungus. As the scout reports come in for this current growing season, the system can adapt so that false positives are factored in and the threshold may be moved upward to have less false positives.

One of skill in the art will appreciate that model validation may benefit from having the scouts also collect a certain number of samples from fields in grid boxes that are not predicted to have scout discernible levels of fungus in order to check for false negatives. As it is ideal that most fields do not have a discernible level of fungus, the checking may be limited to fields in grid boxes close to the cutoff value. Perhaps a field in a grid box with a rating of 90% of the cutoff value so they are deemed not at current risk for a discernible level fungus but would be more likely to have a false negative than a field in a grid box with an estimated value of 50% of the cutoff value.

The use case for these different scenarios is that the historic threshold value would be used early in the growing season when there wasn't much current season information and the threshold value based on current season scout reports would be used more and more as the season progressed.

The blending of historic data with current growing season data can be done using known techniques. For example, one could set up this choice as part of the model fitting using Bayesian Statistics and then express certainty in the use of either of the two threshold setting methodologies. The idea behind this type of technique is fairly standard in binary classification tasks such as this. One can use what is known as area under the curve (AUC) methodologies for assessing the optimization of the algorithm.

One can also use a method that blends information from historic patterns and information about what the weather was for the period this year just before the 50 day point. So if it was atypically cold and rainy the two weeks before day 50, that would skew the estimate towards cold and rainy from the estimate that one would get from purely historical averages. One of skill in the art could select historic data for use that matches some other criteria such as weather patterns dominated by El Niño or La Niña. This could be done using either simple heuristics, actuarial estimation of the relevant multivariate probability distributions, or through the incorporation of an atmospheric based weather prediction model.

Step 1025—Act upon predictions of discernible fungus establishment in particular fields. The typical step would be to dispatch a scout to the fields in grid boxes predicted to have established scout discernible levels of fungus and confirm the presence and possibly the severity of the fungus outbreak.

In some instances a farmer may look at a prediction that there is a high likelihood of a discernible level of fungus in a number of fields a week from now given the weather that has occurred to date combined with the weather forecasted for the near future. The farmer may opt to apply the fungicide prophylactically to reduce the establishment of fungus. As the fungicides cost money and it costs labor and fuel to apply the fungicide, the ability to pinpoint the fields most at risk of fungus or not at risk for fungus helps the farmer make cost efficient applications of fungicide. In some instances, applying fertilizer may help strengthen the crop to withstand the stress from a fungus. The application of fertilizer may be done after scouts confirm the discernible presence of a fungus, based upon a strong indication from the model that fungus is discernably present, or based upon a prediction from the model that fungus is likely to be discernably present in X days based on the current weather projections. Such midseason interventions can help to increase the profitability of treated fields.

By projecting the weather patterns expected in the area for the next week or two, it may be possible to predict an unusually large need for a particular fungicide with enough lead time to get product shipped in to distributors. Having adequate supplies of the appropriate fungicide available ahead of a surge in infected fields in particular grid boxes can be extremely important as an extended delay may mean losses in those fields. As noted above, the fungus prediction may impact the need for a particular fertilizer in addition to the need for fungicides.

The forecast for fields in a particular region growing a particular crop to be at risk for a particular fungus may be used to drive decisions by suppliers to ship fungicide from a national or regional warehouse to local distributors. The same fungus may infect several different types of crops or conversely the same crop may be at risk for several different fungus problems. Unfortunately, the appropriate treatment for a first fungus/crop combination may not be the appropriate treatment for the first fungus on a second crop or for a second fungus on the first crop. Thus, the farm supply dealers benefit from accurate predictions of the number of acres likely to suffer from a specific crop/fungus pair.

### Example

To make the general guidance provided above concrete, an example is given of the various stages of the process. This example is not intended to be limiting as there are many opportunities for those of skill in the art to make adjustments to this process while still employing some or all the teachings of the present disclosure.

Sample Scouting Report Data.

Table 1 provides a list of data from a series of scouting reports for the crop corn and the fungus gray leaf spot where the scouting report noted the presence of gray leaf spot on the corn crop. In order to create a model, there must be a mix of scouting reports that show the discernible presence of the fungus as well as scouting reports where the fungus was not discerned by the scout. As the vast majority of scouting reports do not show fungus discernably present, it may be useful as was done here to have two separate collections of scouting reports, one set where the fungus was discerned and an approximately equal number of scouting reports where the fungus was not discerned. One would choose the subset of negative scouting reports used for model building at random to ensure that the results would be generalizable to the entirety of the collected dataset.

After creating a model, the model may be tested against other subsets of scouting reports (perhaps by altering the date ranges of scouting reports used and omitted) or possibly against the entire set of scouting reports. These extra tests of the model against a different set of scouting reports than were used to create the model checks to ensure that the model is generally useful and not overly fit to the set of scouting reports used to create the model.

TABLE 1

| | | | | | | Crop | |
|---|---|---|---|---|---|---|---|
| S. No. | Field Id | Latitude | Longitude | Density | Create Date | Type | Staging |
| 1 | 715438 | 41.71085 | −93.6157 | Moderate | 10/14/2014 | CORN | (null) |
| | | | | | 13:04 | | |
| 2 | 716422 | 40.7461 | −88.5287 | Slight | 10/16/2014 | CORN | v12 |
| | | | | | 14:46 | | |
| 3 | 685453 | 42.829 | −94.6595 | (null) | 11/18/2014 | CORN | R5 |
| | | | | | 15:14 | | |
| 4 | 685451 | 42.76545 | −94.5408 | (null) | 11/18/2014 | CORN | (null) |
| | | | | | 15:15 | | |
| 5 | 685443 | 42.78996 | −94.516 | (null) | 11/18/2014 | CORN | R4 |
| | | | | | 15:15 | | |
| 6 | 684985 | 42.78938 | −94.5207 | (null) | 11/18/2014 | CORN | R6 |
| | | | | | 15:15 | | |
| 7 | 696353 | 40.91475 | −91.7535 | (null) | 5/18/2015 | CORN | (null) |
| | | | | | 12:32 | | |
| 8 | 698777 | 43.29586 | −94.508 | Slight | 5/19/2015 | CORN | (null) |
| | | | | | 16:10 | | |

Those of skill in the art will recognize that gray leaf spot in corn may come from Cercospora zeae-maydis and Cercospora zeina, the scouting reports and thus the model did not distinguish between these two underlying causes of gray leaf spot. If the treatment required for Cercospora zeae-maydis was different from Cercospora zeina, then the scouting reports and thus the models may be adjusted to have a model for Cercospora zeae-maydis and model for Cercospora zeina.

The field ID number is used by the scouting company and is not required for use in building a model as the latitude and longitude of the scouting report is sufficient to map the scouting report data to the grid.

Density indicates a how densely a crop is planted. Some crops can be planted with different levels of density. Density could impact the onset of fungus by indicating more of a likelihood of water stress on a plant when there is a shortage of water. High density can mean less airflow around plants which may provide prolonged leaf wetness. As density was frequently not reported in scouting reports (null means no report), this variable was not used in the models discussed below, but future models may incorporate this variable.

Staging is an indication of the phenological stage. This variable was not used in the model discussed below but could be used in future models.

Model Framework.

The model framework was inspired by the paper A Simple Generic Infection Model for Foliar Fungal Plant Pathogens, R. D. Magarey, T. B. Sutton, and C. L. Thayer, Phytopathology 2005 95:1, 92-100 (“Magarey 2005”).

The paper builds on the work of others and provides a framework for solving for a the length of wetness duration required to reach a particular level of fungus infestation at a given temperature when the leaf is wet or the ambient humidity is high enough to support growth the root-like threads called hyphae into the host plant.

The first formula in the framework is:

W_{(T)}=Wₘᵢₙ/f_{(T)}but W_{(T)} is capped a W₍ₘₐₓ₎
f_{(T)} is the wetness duration time (in hours) required to reach the critical stage of fungal development for a temperature T.
Wₘᵢₙ is the minimum duration to reach the critical stage of fungal development.
W₍ₘₐₓ₎ is the maximum duration to reach the critical stage of fungal development.
f_{(T)} is the temperature response function which is defined in the second equation.

$${f}_{( T )} = ( \frac{{T}_{max} - T}{{T}_{max} - {T}_{opt}} ) {( \frac{T - {T}_{min}}{{T}_{opt} - {T}_{min}} )}^{( {T}_{opt} - {T}_{min} ) / ( {T}_{max} - {T}_{opt} )}$$

Tₘₐₓ is the maximum temperature for growth, (some fungus do not have a Tₘₐₓ that is low enough to be found outside the laboratory.)
Tₘᵢₙ is the minimum temperature for growth. Note when T is outside of the range of Tₘᵢₙ to Tₘₐₓ, f_{(T)}=zero as there is no growth.
Tₒₚₜ is the optimal temperature for growth (the temperature that provides the fastest growth if the required wetness is present.
T is the mean temperature for a given hour.

D is a period of dry time in hours that stops the growth and causes the growth calculations to restart. Note, this is a deviation from the Magarey 2005 paper which used D₅₀ as the duration of a dry period at relative humidity below 95 percent that will result in a 50% reduction in fungus colonization.

Initial and Final Values for the Model.

Magarey 2005 paper had a great number and variety of crops, primarily horticultural crops. In order to generate useful starting values, the model used an average of the Magarey 2005 paper parameters for row crops (wheat/barley/soybeans/rapeseed). Those of skill in the art will recognize that initial values could be estimated using another paper, or making other choices on what values to include or to weigh most heavily. The system benefits from initial values that are reasonable in order to reduce the computational resources but as shown below the final values are often very different from the initial values so the success of the model is not contingent on perfection in establishing the initial values.

A careful observer will note that the initial values and final values for Wₘᵢₙ, Wₘₐₓ, and Tₒₚₜ are unchanged. This is not a mathematical fluke. Final values were not sought from the parameter fitting process. While in theory, an optimal solution would have optimized values for all parameters, in this example the results from the model were sufficiently good after fitting several parameter values that the process did not proceed to solve for Wₘᵢₙ, Wₘₐₓ, or Tₒₚₜ.

The model process may be iterative. A person seeking to create a model may initially set all but one parameter values to constants that represent reasonable estimates for their values and then solve for the first parameter. Then the process may be repeated with allowing a second parameter to vary in addition to the first to come up with a set of values for the first and second parameter. The value of the first parameter may be different when solved with a floating second parameter than when the only varying parameter was the first parameter. This process may be extended to allow the first, second, and a third parameter to vary while holding the remaining parameters at guessed values. At some point, the model becomes sufficiently useful, that the user may stop increasing the number of parameters that vary during the model fitting.

The decision on which parameters to vary and which to leave fixed may be based upon a combination of domain specific knowledge and small trial experiments to conduct sensitivity analysis on how much that variable might influence the outcome.

A number of different leaf wetness models were considered. These are the Ext model (from “Multi Metric evaluation of leaf wetness models for large-area application of plant disease models (2011)” by Bregaglio et al.), the CART model (from Model to Enhance Site-Specific Estimation of Leaf Wetness Duration), the Fixed Threshold Model, the Leaf Wetness Reference Model “LWR”, the Dewpoint Parameterization Model, and the Surface Wetness Energy Balance Model. Information on leaf wetness models is readily available to those of skill in the art. A starting point for various models is provided below. These papers are incorporated by reference to this disclosure.
EXT—Wichink Kruit, R. J. W., van Pul, A. J., Jacobs, A. F. G., Heusinkveld, B. G., 2004. Comparison between four methods to estimate leaf wetness duration caused by dew on grassland. In: Conference on Agricultural and Forest Meteorology, 2004, American Meteorological Society, Vancouver.
CART—Kim, K. S., Taylor, S. E., Gleason, M. L., Koehler, K. J., 2002. Model to enhance site specific estimation of leaf wetness duration. Plant Dis. 86, 179-185.
FT—Sentelhas, P. C., Dalla Marta, A., Orlandini, S., Santos, E. A., Gillespie, T. J., Gleason, M. L., 2008. Suitability of relative humidity as an estimator of leaf wetness duration. Agric. Forest Meteorol. 148, 392-400.
LWR—Sentelhas, P. C., Gillespie, T. J., Gleason, M. L., Monteiro, J., Pezzopane, J., Pedro, M. J., 2006. Evaluation of a Penman-Monteith approach to provide “reference” and crop canopy leaf wetness duration estimates. Agric. Forest Meteorol. 141, 105-117.
DP—Garratt, J. R., Segal, M., 1988. On the contribution to dew formation. Bound.-Lay. Meteorol. 45, 209-236.

To illustrate the diversity of models, Table 2 shows the various parameters used by the different models and the starting values. Notice that while a number of the models use solve for the number of continuous hours of relative humidity needed to reset the growth of the fungus, the starting values used in the various leaf wetness models are not the same.

In order to hunt for appropriate values for various parameters, one needs a sensible lower bound and upper bound for the parameter. The deviation impacts the degree to which the value of the parameter can change between subsequent iterations of the annealing process.

While those of skill in the art could implement this in different ways, one suitable way is to use the deviation as more of an indication of range of allowable next steps. If a variable has a current value of 5 and a deviation of plus or minus 2, then the system may be set to limit the maximum deviation from the current value to not more than 2. This would mean the value for the next round would be at least 3 and no more than 7. Within the range, the likelihood of any particular value may be a uniform distribution although other options could be used.

Choice of this deviation number is left to the discretion of the person using the teachings of the present disclosure. Having a bigger deviation allows the parameter to be more volatile within the maximum range between the upper bound and lower bound for that parameter. If one believes that the optimal value is apt to be close to the initial value, one may set the deviation value to be relatively small. If one believes that the optimal value might be far from the initial value and towards either the upper bound or the lower bound, one might select a relatively large deviation to allow for more movement within the upper bound/lower bound range. As the modeling process continues, subsequent runs may use revised starting values and progressively smaller deviation values to allow for less variation.

To pick a deviation value, a person of skill in the art may do some quick but coarse fittings of the model to get a sense for what combination of the parameters got explored by the algorithm. For some parameters, where there was a smaller range that was explored, it may make sense to start with a smaller deviation value than other parameters that had bigger explored ranges in preliminary model runs.

Leaf Wetness Models.

While a detailed discussion of the various leaf wetness models is not needed here as those of skill in the art will have access to these models, a brief overview of a few models may be useful to highlight that the wetness models work with different frameworks and may thus be better for some crops than others.

Extended Threshold Model (ExtModel).

This model comes from the work of Witchink Kruit J., Addo W., van Pul J., Jacobs F. G., and Heusinkveld G. The extended threshold model is the simplest model of the LeafWetness library. The extended threshold model implements a very empirical approach for the calculation of leaf wetness by considering as wet the hours in which the relative humidity of the air is above 87%. Then, for values of relative humidity between 70-87%, the model considers as wet the hours in which there is a positive increment of 3%. The hours in which relative humidity is under 70% are considered as dry. The modelling efforts in accordance with the present disclosure started with the values set forth below but the values were allowed to vary to better fit the data.

LWR (Leaf Wetness Reference).

The LWR model comes from the work of Sentelhas C. P., Gillespie J., Gleason L. C., Monteiro B. M., Pezzopane M., and Pedro Jr. J., 2006. The LWR model implements a Penman-Monteith approach for the calculation of leaf wetness. The LWR model assumes that air temperature measured at a given height above turf grass at a standard weather station is equivalent to temperature at the same height above the top of a crop canopy, and that adding a resistance item to the model is enough to account for the air layer from measurement height, above the canopy, to the level of the leaves.

The model simply treated the rain interception using measured rainfall amount and a fixed maximum amount of water in the rain reservoir (0.6 mm).

Other Models.

Introductory information on the other leaf wetness models are readily available including information found at http://agsys.cra-cin.it/tools/leafwetness/help/

While this disclosure notes a number of leaf wetness models, this list is intended to teach that the model can consider more than one wetness model. Those of skill in the art will understand that other leaf wetness models may be used with the teachings of the present disclosure.

A number of models use the height of the crop. This number is calculated based on the time of year and the normal age for a crop at that time.

TABLE 2

| | | | | | |
|---|---|---|---|---|---|
| Parameter and | Lower | Upper | | Starting | Comment/Source |
| unit | bound | Bound | Deviation | Value | of information. |

Parameters used in more than one leaf wetness models.

| | | | | |
|---|---|---|---|---|
| D (number of | 0 | 36 | 5 | 12 (for Ext, |
| continuous hours | | | | CART, FT) |
| with relative | | | | 10 for |
| humidity below 95% | | | | LWR; |
| to reset fungus | | | | 24.95 for |
| growth to zero). | | | | Dew Point |
| Crop height in meters | 1 | 2.999 | 0.5 | 2.8(for |
| | | | | CART, |
| | | | | LWR) |
| | | | | 2.95 (for |
| | | | | Dew Point) |

Parameters used in ExtModel Leaf Wetness Model

| | | | | |
|---|---|---|---|---|
| LowThreshValues | 60 | 75 | 3 | 70 |
| HighThreshValue | 76 | 96 | 3 | 84 |

Parameters used in CART Leaf Model

| | | | | |
|---|---|---|---|---|
| Dew Point Degrees | 2 | 5 | 0.5 | 3.7 |
| (Celsius) | | | | |
| Wind Speed | 1 | 5 | 0.5 | 2.5 |
| (Kilometers Per Hour) | | | | |
| Relative Humidity | 70 | 95 | 4 | 87.8 |
| Threshold Value | | | | |

Parameters used in FT Leave Wetness Model

| | | | | | |
|---|---|---|---|---|---|
| Relative Humidity | 60 | 90 | 5 | 83 | Note the relative |
| Threshold Value | | | | | humidity values for |
| | | | | | this model is |
| | | | | | different from the |
| | | | | | CART Leaf model. |

Parameters used in the LWR Leaf Wetness Model

| | | | | | |
|---|---|---|---|---|---|
| LcMaxValues (unit | 0.001 | 2 | 0.3 | .6 | |
| less) | | | | | |
| RainResevoirValues | 0.001 | 2 | 0.3 | .6 | |
| dimMockLeafValues | 0.001 | 0.4 | 0.05 | 0.07 | Used to calculate |
| | | | | | boundary layer |
| | | | | | resistance. |

Parameters used in Dew Point Leaf Wetness Model

| | | | | |
|---|---|---|---|---|
| CNR Values (Unitless) | 1 | 4 | 0.3 | 2.11 |

Table 3 provides starting values for a number of fungus/crop combinations. These values may be obtained from controlled laboratory studies or from earlier models that worked with the same fungus but with a different crop. If neither of these sources was available then starting values may be based on a similar fungus within the same genus or an average set of values for several members of an analogous family of fungus members. Use of a good starting point, reduces the amount of computational resources needed to come to good parameter choices. Note that the set below includes three different fungus types that are a problem for corn. Notice that the Tₘᵢₙ and Tₘₐₓ values differ across the three corn fungus types.

TABLE 3

| | | | | |
|---|---|---|---|---|
| Parameter | Minimum | Maximum | Deviation | Starting Value |

For Common Corn Rust

| | | | | |
|---|---|---|---|---|
| Tₘᵢₙ | 10 | 18 | 2 | 14.4 |
| Tₘₐₓ | 24 | 32 | 2 | 27.8 |

For Gray Leaf Spot (Corn)

| | | | | |
|---|---|---|---|---|
| Tₘᵢₙ | 17 | 25 | 2 | 21.1 |
| Tₘₐₓ | 27 | 34 | 2 | 31.1 |

For Northern Corn Blight

| | | | | |
|---|---|---|---|---|
| Tₘᵢₙ | 14 | 22 | 2 | 18.3 |
| Tₘₐₓ | 23 | 31 | 2 | 27.2 |

For Soybean Rust

| | | | | |
|---|---|---|---|---|
| Tₘᵢₙ | 6 | 14 | 2 | 10.0 |
| Tₘₐₓ | 26 | 34 | 2 | 30.0 |

Simulated annealing may be used to find a fit for the given model that includes the choice of leaf wetness predictions from several leaf wetness models.

The simulated annealing process is repeated with different initial values to ensure that the solution is not dependent on the initial values.

For example, for fungus=(common corn rust) and crop=(corn), the process would start with Tₘᵢₙ=(14.4), Tₘₐₓ=(27.8), and initial D values for the different wetness models as indicated in Table 4.

TABLE 4

| Value | Min | Max | Deviation | Start Value |
|---|---|---|---|---|
| Tₘᵢₙ | 10 | 18 | 2 | 14.4 |
| Tₘₐₓ | 24 | 32 | 2 | 27.8 |
| D | 0 | 36 | 5 | D would start as |
| | | | | 12 in some |
| | | | | wetness models, |
| | | | | 10 in another |
| | | | | and 24.95 for |
| | | | | yet another |

A model using a particular leaf wetness model would include all the relevant wetness model initial values which are independent of fungus/crop

For the next iteration, the annealing process would start with set of values equal to the starting values from the first run plus or minus a deviation value so that different portions of the solution space are used as starting points without using starting points that are unlikely to be in a relevant part of the solution space.

Simulated Annealing.

In order to determine which of these models produced the most reliable predictions, a variable selection algorithm that including all relevant parameters for the leaf wetness model being studied, and the relevant parameters entered above were entered into a Simulated Annealing Algorithm to search the variable space. This algorithm drew data from uniform distributions over preset ranges. The algorithm was programmed to have limited “memory” of previous results to prevent it from falling into local maxima at the expense of global maxima. The decay rate parameter was selected based on trial and error running to make sure the parameter space was adequately searched. In addition how far back in time the analysis looked relative to the observation date of the scouting report was a varied parameter. For all studied combinations of crops/fungi, a date range of 60 days into the past was chosen as the ideal length of time to look back. While there may be a particular fungus/crop combination that may not need a 60 day period, 60 days was chosen as it captured all the fungus growth events that happened during a growing season.

Those of skill in the art will appreciate that there are many different ways to use simulated annealing. The teachings of the present disclosure may be used with different flavors of simulated annealing. Simulated annealing has been used with the teachings of the present disclosure where the simulated annealing was set up as follows:
Express an annealing temperature as a number between 0 and 1.
The Current Annealing Temperature can be represented as CAT.
Choose a random number (RN) between 0 and 1.
Compare the Random Number to the Current Annealing Temperature number.
If RN<CAT then change all of the parameters that you are changing in the model by selecting new values for a uniform distribution within plus or minus one deviation of the current value for that parameter.
If CAT<RN<2*CAT, then change all but one parameter.
If 2*CAT<RN<3*CAT, then change all but two parameters.
If 3*CAT<RN<4*CAT then change all be three parameters
Continue until only one parameter is being changed. So if there were five parameters that are subject to change in a model then you would end with 4*CAN<RN<5*CAT then change all but four parameters. Once the number of parameters to be changed in the next iteration is set, the choice of which parameters to change may be random.

As the annealing process continues and the current annealing temperature slowly drops, fewer parameters are changed each time until most iterations are only changing one parameter as the current annealing temperature is so small that most random number are many multiples of the current annealing temperature. The cooling may be a reduction of the temperature by a fixed percentage each iteration and having a cutoff where the process is considered complete (as a percentage based decay will not reach zero). Alternatively, the cooling may be done in fixed increments.

Although there were several leaf wetness models that were tested, each simulated annealing process used just one leaf wetness model. Each set of parameters from simulated annealing for that crop/fungus/leaf wetness model triplet was tested by cross validation to ensure that the set of parameters were generally useful and not over fit to the data used in creating the parameter set.

Note, one of skill in the art will recognize that many of the benefits from the teachings of the present disclosure may be obtained without going through the extra effort to solve for different sets of parameters from different models that use different leaf wetness models. The literature may suggest that a particular leaf wetness model is generally useful for a particular type of crop or type of fungus and one may elect to create a model using that leaf wetness model without considering other leaf wetness models.

Cross Validation.

Cross validation analyses to help control for overfitting as well as ultimately tested in an out of sample validation analysis. A model using a particular leaf wetness model may be made using simulated annealing using data from 2011-2014 and then tested for the ability to predict the 2015 data. A second model may be made by simulated annealing again using the same particular leaf wetness model could be made using 2011-2013 and 2015 but omitting 2014 and then tested against 2014 data. This process can be repeated with the omission of different years from the model creation with continued use of the same particular leaf wetness model. By repeating this process and omitting a different year of data from the model making, one can look whether the different models based on different combinations of years had similar results. Checking a model fit via cross validation is a standard technique known to those of skill in the art and need not be explained in detail here.

As the number of simulated annealing runs needed grows quickly when there are several leaf wetness models and a number of runs per leaf wetness model in order to perform cross validation, it may be expedient to use small subsets of the overall data set at this stage. As noted below, a much larger data set may be used for final cross-validation tests of the chosen set of parameters for the crop/fungus/leaf wetness model.

Repeat for Each Leaf Wetness Model.

The process of simulated annealing was repeated for each leaf wetness model. The parameter set produced by simulated annealing for that particular crop/fungus/leaf wetness triplet was tested by cross validation as discussed above. From the cross validation tests of the parameter sets for each leaf wetness choice, one set of model parameters with reliance on one leaf wetness model was deemed superior as being able to predict that a field at a location would have a scout discernible presence of fungus.

Testing Against Larger Data Set.

Finally the selected best of breed model based on a particular lead wetness model was tested against the entirety of the available data to get a complete measure of accuracy. The model included data from 2011-2015.

One of skill in the art would be able to say that certain historic data may not be useful. For example, if the industry switched to a new fungus resistant cultivar, then old data with the prior cultivar would be dropped from the model once an adequate level of data was available from the new cultivar. A rework of the weather monitoring system that added many new weather stations and changed the interpolation of weather data to grid locations without weather reporting stations might be a reason to discount data from the time before the upgrade.

The various cross validation exercises lead to different values for the parameters in the set of parameters for that model. These different values can be averaged to provide for a set of parameters that is thought to be more generally predictive of future outcomes than the parameters from any one cross validation exercise.

Ultimately a model using a particular leaf wetness model with a set of parameter values would be found to have the best cross validation results and be deemed the model to use for predicting the presence of the particular fungus on a particular crop at a particular location on a particular date contingent on the weather that preceded that particular date for the selected duration (such as 60 days).

Not Likely/Likely Binary Value.

After using simulated annealing and cross-validation to create a set of models for a particular crop/fungus/leaf wetness model triplet, the best model with set of parameters is selected for the particular crop/fungus pair. In other words, the leaf wetness model that provides the best model for the crop/fungus pair is chosen and the other models based upon other leaf wetness models are discarded. Once a model and set of parameters is selected, it is time to set a criteria for dispatching scouts to particular fields as the output of the model is going to be a number on a continuum indicating the likelihood that a discernible amount of fungus will be found on a particular crop at a particular location on a particular date. The continuum value can be converted to a binary value—likely or not likely to have discernible fungus. The process sets all model likelihood values below a threshold to a binary not likely and all model likelihood values above the threshold to a binary likely.

The continuum value is a score of the likelihood that a particular fungus will be found by scouts on a particular crop in a particular geographic grid based on the weather experienced by that grid for a period of time that ends on date x. If date x is in the past, then all of the weather data would be actual weather or interpolations based upon actual data. If date x is in the future, some portion of the weather experienced for a period of time that ends at date x would be forecasted weather.

Note that there may be some discrepancy between when a fungus is established such that it will remain even after an extended dry period of the application of fungicide and when it is so prevalent that it is found during the scouting checks. However, having a model that accurately predicts when the weather sequence will cause a particular crop at a particular location to have fungus become sufficiently established be detected during a scouting visit will be useful for providing warnings to act before the fungus is established to the level that the fungus is noted by the scout. Likewise, the model may be used to efficiently use the limited resource of scouting visits to deploy scouts to a high percentage of fields likely to have a discernible level of fungus. Once the scout confirms the presence of fungus, the crops may be treated to avoid the further establishment of fungus and thus avoid agronomically significant levels of fungus in the field.

As discussed above, there are three levels of fungus presence:
established,
discernible to a scout, and
agronomically significant damage.

Some minor establishment, even if discernible by the scouts is tolerable and not agronomically significant. The crop is still valuable and timely intervention to apply fungicides and provide other treatment (such as adding nutrients to help the plants fight the fungus) may preserve the economic value of the crop. This is why farmers employ scouts to look for the onset of fungal damage in time to take corrective action.

By having a model that predicts a discernible amount of fungus, there are several advantages that benefit the farmers. One advantage is that scarce scouting resources may be deployed efficiently to places most likely to have something for the scout to discern (and some additional locations to help tune the model). Secondly, the model combined with weather predictions can be used to predict locations that will have discernible fungus so that prophylactic measures can be taken to eliminate or reduce the amount of fungal establishment.

TDV.

A parameter of interest is Threshold Discriminating Value (TDV). The model selects a TDV value using the Area Under the Curve (AUC) methodology. A series of TDV values are tested against the historical data. The range of continuum likelihood values will vary from model to model. A starting point for a possible TDV value may be the average continuum value for the scouting reports that had discernible amounts of fungus. A series of possible TDV values clustered around the starting point could be tested to see how well that TDV breakpoint would do with respect to converting the continuum likelihood values into the binary not likely/likely values.

The process may use Receiver Operating Characteristics (ROC) metrics such as Area Under Curve (AUC) to look to see whether TDV value being tested optimized the number of true positives (where a continuum value above the proposed TDV value was indeed found to have discernible fungus) and false positives (where a continuum value above the proposed TDV value matched a scouting report that did not show discernible fungus). Moving the TDV value lower will increase both the number of true positives and the number of false positives but it is the balance of the two that is evaluated. For some applications, the TDV value may be biased to get more true positive values while tolerating more false positive values (erring on the side of dispatching scouts to more fields and accepting that a greater number of those visits will not find discernible fungus). This may be appropriate if there is a relatively small window between discernible fungus and agronomically significant damage. In other applications the TDV value may be biased with a greater emphasis on reducing the number of false positives as there may be a more relaxed window between discernible fungus and agronomically significant damage and the model may seek to reduce the expense of dispatching scouts. Thus, not all models for different crop/fungus pairs will have the same criteria for balancing the true positive/false positive consequences of a TDV choice.

The concepts associated with Receive Operating Characteristics and more specifically Area Under Curve (AUC) would be known to those of skill in the art and need not be set forth here. Those unfamiliar with the concepts and desiring an explanation on these topics may start at https://en.wikipedia.org/wiki/Receiver_operating_characteristic#Area_under_the_curve.

Table 5 provides a set of TDV values for the four fungus/crop pairs listed above. As the range of likelihood continuum values will vary from model to model, the value of the optimal TDV breakpoint may vary considerably from model to model.

TABLE 5

| Fungus | Crop | TDV value |
|---|---|---|
| Common Corn Rust | Corn | 97.6 |
| Gray Leaf Spot | Corn | 44.8 |
| Northern Corn Blight | Corn | 144 |
| Soybean Rust | Soybean | 168 |

Tuning of the Models.

After a model with a set of parameters and a TDV value used a not likely/likely breakpoint that a fungus will be scout discernible, scouts may be deployed to locations with a fungus value above the TDV threshold. To the extent that there are a sizeable number of false positive values (where value was in excess of the TDV threshold but fungus was not scout discernible), the TDV value may need to be moved upward to reduce the number of false positives. Additional field locations with a value below but close to the TDV value could be checked by scouts to look for false negative values where the model value is below the TDV value but fungus was found to be scout discernible.

Those of skill in the art can devise various ways to select locations to be sample by a scout visit based upon TDV values. One way to pick locations to sample would be to sample locations at random with the chance of the location being sampled being inversely weighted by its score relative to the threshold. This algorithm would result in fields that had scores close to but on either side of the threshold value would be sampled the most. Conversely, fields with TDV values far much above or much below the critical TDV value would be sampled less frequently as the model has more “certainty” about the expected results of a scouting visit and it is less likely that the scouting visit will document an unpredicted result. Having at least some sampled locations that have TDV values well away from the critical TDV value is considered a good practice as it is important if possible to have validation metrics sample different parts of your dataset.

Alternatives and Variations.

Other Parameter Optimization Techniques.

Simulated Annealing is but on optimization technique that may be employed to determine the optimal set of model parameters to predict whether a fungus will or will not be present. Others of skill in the art will recognized that other optimization techniques may be employed. A partial list is found at https://en.wikipedia.org/wiki/Simulated_annealing. This list contains:
Interacting Metropolis-Hasting algorithms (a.k.a. Sequential Monte Carlo) combined simulated annealing moves with an acceptance-rejection of the best fitted individuals equipped with an interacting recycling mechanism.
Quantum annealing uses “quantum fluctuations” instead of thermal fluctuations to get through high but thin barriers in the target function.
Stochastic tunneling attempts to overcome the increasing difficulty simulated annealing runs have in escaping from local minima as the temperature decreases, by ‘tunneling’ through barriers.
Tabu search normally moves to neighboring states of lower energy, but will take uphill moves when it finds itself stuck in a local minimum; and avoids cycles by keeping a “taboo list” of solutions already seen.
Dual-phase evolution is a family of algorithms and processes (to which simulated annealing belongs) that mediate between local and global search by exploiting phase changes in the search space.
Reactive search optimization focuses on combining machine learning with optimization, by adding an internal feedback loop to self-tune the free parameters of an algorithm to the characteristics of the problem, of the instance, and of the local situation around the current solution.
Stochastic gradient descent runs many greedy searches from random initial locations.
Genetic algorithms maintain a pool of solutions rather than just one. New candidate solutions are generated not only by “mutation” (as in SA), but also by “recombination” of two solutions from the pool. Probabilistic criteria, similar to those used in SA, are used to select the candidates for mutation or combination, and for discarding excess solutions from the pool.
Graduated optimization digressively “smooths” the target function while optimizing.
Ant colony optimization (ACO) uses many ants (or agents) to traverse the solution space and find locally productive areas.
The cross-entropy method (CE) generates candidate solutions via a parameterized probability distribution. The parameters are updated via cross-entropy minimization, so as to generate better samples in the next iteration.
Harmony search mimics musicians in improvisation process where each musician plays a note for finding a best harmony all together.
Stochastic optimization is an umbrella set of methods that includes simulated annealing and numerous other approaches.
Particle swarm optimization is an algorithm modelled on swarm intelligence that finds a solution to an optimization problem in a search space, or model and predict social behavior in the presence of objectives.
The runner-root algorithm (RRA) is a meta-heuristic optimization algorithm for solving unimodal and multimodal problems inspired by the runners and roots of plants in nature.
Intelligent water drops algorithm (IWD) which mimics the behavior of natural water drops to solve optimization problems
Parallel tempering is a simulation of model copies at different temperatures (or Hamiltonians) to overcome the potential barriers.

Closely Related Fungus.

May be able to create a model for a new fungus if the fungus is closely related to a fungus that has already been modeled that uses a smaller history of scouting reports than was originally used for creating a model for a fungus quite unlike any previously modeled fungus. Use of a single year of scouting reports may be sufficient to validate that the model is useful.

Weather Values.

While the models discussed above were fit using weather data with a granularity of hourly, those of skill in the art will appreciate that other weather sampling may provide useful information to form a model to predict whether a particular fungus is established on a particular crop at a particular location at a particular time. For example, a common way of reporting data for an area is to report the expected high temperature and low temperature for a day along with indications of other parameters such as wind speed, rain, or humidity without having a value for each hour. Those of skill in the art would be able to adopt the teachings of the present disclosure accordingly. It is expected that having less detailed weather data from having only 2 parameter arrays per day rather than 24 parameter arrays per day would lead to a less precise model but the model may be sufficient to provide useful guidance.

No TDV.

One of skill in the art can recognize that having a binary value to convert an analog predictive value into a binary—Not Likely/Likely—to have scout discernible levels of fungus would be a useful tool in dispatching scouts as the total number of fields thought likely to have discernible levels of fungus could be tallied. This tally could be used in allocating scout resources (for examples, does it make sense to pay for overtime or to divert scouts from checking another crop?). However, one could benefit from many of the teachings of the present disclosure by simply using the analog predictive value and dispatching scouts to the fields with the highest predictive values for that particular crop/fungus pair. One might include some number of randomly chosen fields in addition in order to look for the presence of fungus in fields without the highest predictive values in order to look for any problems in the model or changes to the crop or fungus that may make the model fail to accurately rank likelihood.

One of skill in the art will recognize that some of the alternative implementations set forth above are not universally mutually exclusive and that in some cases additional implementations can be created that employ aspects of two or more of the variations described above. Likewise, the present disclosure is not limited to the specific examples or particular embodiments provided to promote understanding of the various teachings of the present disclosure. Moreover, the scope of the claims which follow covers the range of variations, modifications, and substitutes for the components described herein as would be known to those of skill in the art.

The legal limitations of the scope of the claimed invention are set forth in the claims that follow and extend to cover their legal equivalents. Those unfamiliar with the legal tests for equivalency should consult a person registered to practice before the patent authority which granted this patent such as the United States Patent and Trademark Office or its counterpart.

What is claimed is:

1. A method to predict whether a particular fungus will be observed by a scout checking on a particular crop, at a particular location; the method comprising:
A) obtaining a set of scouting reports containing information on whether the particular fungus was observed in a sample of the particular crop on a specific date and specific location;
the set of scouting reports containing observations taken over a growing season for the particular crop;
the set of scouting reports containing observations from more than one location; and
the set of scouting reports containing some observations that the particular fungus was found on the particular crop and some observations that the particular fungus was not found on the particular crop;
B) obtaining weather information leading up the to the specific date for each of the scouting reports for the particular locations for a set of growing seasons for the particular crop such that weather information exists for the growing seasons corresponding to the set of scouting reports to be relied upon for creating a model;
C) obtaining a model framework to model growth of the particular fungus for the particular crop;
D) selecting a parameter optimization technique to determine an optimal set of model coefficients for the model framework for the particular fungus and particular crop;
E) selecting a set of parameters for the model framework that will be allowed to vary within the parameter optimization technique;
F) providing initial values for at least some parameters to a program running the parameter optimization technique;
G) providing data from the scouting reports to the program running the parameter optimization technique, the data including observations where the particular fungus was observed and including observations where the particular fungus was not observed;
H) providing the weather information for at least the locations corresponding to the scouting reports provided to the program running the parameter optimization technique for a set of growing periods relevant to the scouting reports provided to the program running the parameter optimization program;
I) using the program running the parameter optimization technique to obtain a set of values for the selected set of parameters for the model framework such that the model may be used to provide a predictive score on whether the particular fungus will be observed on the particular crop at a particular location after a particular sequence of weather conditions at that particular location;
J) obtaining weather information for a period of time for a set of particular locations and provide a set of predictive scores of whether on a particular date, the particular fungus may be observed on the particular crops at locations within the set of particular locations; and
K) providing access to the predictive scores so that scouts are dispatched to locations with predictive scores above a threshold value to check for the particular fungus on the particular crop.

2. The method of claim 1 wherein the scouting reports contain observations from at least two different years.

3. The method of claim 1 wherein the parameter optimization technique is simulated annealing.

4. The method of claim 1 wherein the step of obtaining weather for the period of time to provide a set of predictive scores of whether on a particular date, the particular fungus may be observed on the particular crop at locations within the set of particular locations includes weather data for weather that has already occurred before the particular date.

5. The method of claim 1 wherein the step of obtaining weather for the period of time to provide a set of predictive scores of whether on the particular date, the particular fungus may be observed on the particular crop at locations within the set of particular locations includes weather data that is predicted for a time period between a current date and the particular date.

6. The method of claim 1 wherein the step of obtaining weather information leading up the to the specific date for each of the scouting reports for the particular location for a set of growing seasons for the particular crop, obtains hourly weather information.

7. The method of claim 1 wherein the step of obtaining weather information leading up the to the specific date for each of the scouting reports for the particular location for a set of growing seasons for the particular crop, obtains weather information representative of a high temperature and a low temperature experienced at the particular location on the specific date.

8. The method of claim 1 wherein the model is tested and refined by dispatching scouts to visit locations with predictive scores below a threshold value to check for the particular fungus on the particular crop in order to find false negatives.

9. The method of claim 1 wherein weather information is assumed to apply to all crops within a particular range of longitude and latitude values.

10. The method of claim 1 wherein a first set of model coefficients are selected for a first model using a first leaf wetness model and a second set of model coefficients are selected for a second model using a second leaf wetness model and then selecting either the first set of model coefficients for the first model using the first leaf wetness model or the second set of model coefficients for the second model using the second leaf wetness model based on an ability to predict whether the particular fungus was observed by a scout checking on a particular crop in scouting reports not used for determining the first set of model coefficients or the second set of model coefficients.

11. The method of claim 1 wherein a TDV value is obtained to indicate a breakpoint between whether it is likely or not likely that a scout will observe the particular fungus on the particular crop, at the particular location, on the particular date.

12. The method of claim 11 wherein the TDV value is obtained using Receiver Operating Characteristic metrics.

13. The method of claim 11 wherein the TDV value is adjusted during a growing season as scouting reports find false negative indications from scouting reports taken at field locations deemed to be not likely to have the particular fungus on the particular crop, at a particular location, on the particular date.
